(19) United States
(12) Patent Application Publication
(10) Pub. No.: US 2016/0002023 A1
(43) Pub. Date: Jan. 7, 2016

(54) SELF-MEASURING CONTAINER AND METHOD FOR REMOVING CONTENT THEREIN

(71) Applicant: BEIJING RED-SEA TECH CO., LTD., Beijing (CN)

(72) Inventors: Zengxin CHEN, Beijing (CN); Shumin LUO, Beijing (CN)

(73) Assignee: BEIJING RED-SEA TECH CO., LTD., Beijing (CN)

(21) Appl. No.: 14/771,507

(22) PCT Filed: Mar. 5, 2014
(86) PCT No.: PCT/CN2014/072898

§ 371 Date: Aug. 31, 2015

(30) Foreign Application Priority Data
Mar. 5, 2013 (CN) 201310069274.1

(51) Int. Cl. B67D 7/02; B67D 7/36; G01F 22/02

(52) U.S. Cl. CPC B67D 7/0205; G01F 22/02; B67D 7/36

(57) ABSTRACT

A self-measuring container and method for removing content therein, the container comprising: a container body, a pressure changing part, a pressure transferring channel (4), a control valve (5) and an outflow channel (6); a plunger is provided in the pressure transferring channel; the control valve comprises a valve body provided with at least two tubes respectively connected to the container body and the outflow channel, and a valve core provided with an inner channel and at least one passage, the inner channel communicating with the pressure transferring channel and the passage; the valve core is connected to the plunger via a sliding component, thus allowing the plunger to drive the valve core to move in the valve body when the pressure generated by the pressure changing part changes.

### BACKGROUND

1. Technical Field

The present invention relates to a self-measuring container and a method for removing content in the container, and in particular to a container which is cheap and suitable for large-scale integrated production, a container from which content can be removed conveniently, quickly and quantitatively, and a method for removing content in the container.

2. Related Art

In daily life, people may use many liquids or pastes, such as washing liquids, sterilizing liquids, shampoos, body washes, toothpastes, soy, vinegar, salad dressing, honey, edible oil and liquid medicines. Containers containing these liquids or pastes are mostly disposable articles, which often only pay attention to labeling and beautiful effects but pay little attention to how to conveniently remove the content, and an inverted toppling method and a method for removing by a pressing pump are commonly used. Problems existing in the inverted toppling method have been fully described in other literatures, for example, the method cannot determine the quantity, is easy to pollute or waste the content, is inconvenient in use, or is prone to oxidation in contact with the air; methods for removing hand sanitizer and shampoos and some simple transformed removal methods also have some disadvantages:

1. The amount of a liquid removed by using a pressing pump cannot be controlled precisely. A force generated by downward press of a pressing device cannot be controlled precisely, so the amount of the liquid removed often can only be measured with the number of presses, and the amount of the liquid removed cannot be controlled precisely.

2. Viscosity and consistency of the liquid removed cannot be too high. The pressure drop of the pressing device is big as the pressing device needs to suck the liquid to a high level and then remove the liquid, and if viscosity and consistency of the liquid are too high, the liquid cannot be sucked to a high level and cannot be removed.

3. The manufacturing cost is high. The pressing device has a complex structure, necessary parts such as container walls are not utilized, and thus the manufacturing cost is high.

4. The amount of single removal is less and continuous removal is impossible. The pressing device can only remove content in a limited space near a straw outlet each time, after the content in the space is removed, the content can be removed only after being inhaled from the container below, and thus the liquid can only be removed in small volume and intermittently, and continuous removal is impossible.

5. The pressure at a container outlet is low, and is not conductive to forming foam or spray. A too big pressure drop of a removal tube causes the pressure of the container outlet to be too low.

A simple and practical container is required in people's life, so that each removal can be controlled at will and less affected by the outside air or impurities, and liquids or pastes with great viscosity and consistency can be removed.

### SUMMARY

To solve the problem existing in the prior art that there are no containers and utensils from which content is conveniently removed, the present invention provides a container, the container, in addition to a container body, further including a pressure changing part, a pressure transferring channel, a control valve and an outflow channel;

the pressure changing part being a part that can generate a positive and negative pressure change in the pressure transferring channel;

the pressure transferring channel being internally provided with a plunger that reciprocates with the pressure change generated by the pressure changing part, the plunger being capable of transferring to the control valve a pressure applied to the pressure transferring channel by the pressure changing part;

the outflow channel being a channel that allows content to flow out of the container;

the control valve including a valve body and a valve core, the valve core being located in a valve body cavity;

the valve body being provided with an opening on one side opposite the pressure transferring channel;

the valve body being provided with at least two tubes, respectively in communication with a channel leading to the bottom of the container body and the outflow channel;

the valve core of the control valve being provided with an inner channel and at least one passage, the inner channel communicating with the pressure transferring channel and the passage;

the valve core of the control valve being connected to the plunger via a sliding component, thus allowing the plunger to drive the valve core to move in the valve body when the pressure generated by the pressure changing part changes; and when the pressure changing part generates a positive pressure, the valve core being located on one side in the valve body which is away from the pressure transferring channel, and the passage communicating with the tube on the valve body which leads to the outflow channel and being disconnected from the tube on the valve body which leads to the bottom of the container body; when the pressure changing part generates a negative pressure, the valve core being located on one side in the valve body which is near the pressure transferring channel, and the passage communicating with the tube on the valve body which leads to the bottom of the container body and being disconnected from the tube on the valve body which leads to the outflow channel.

The container has a simple structure, enables mass production, does not have too precise requirements for a product structure, can reduce the manufacturing cost, does not have any excessively protruding portions, and facilitates packing and transportation. In use, the content can be conveniently and quickly removed at will.

The sliding component used in the container includes a rod-like object having a nested structure (similar to a fishing-pole-like telescopic rod having an extending and contracting function), also includes a straight rod which does not have a nested structure but can extend itself into or pull itself out of a connected plunger or valve core, so as to change a distance between the plunger and the valve core, and further includes a tubular object connected to one end of the valve core, the tubular object is internally provided with a plunger, and the plunger is “a plunger disposed inside the pressure transferring channel and moving with a pressure change generated by an external pressure changing part”. When the sliding component (rod-like object) extends and contracts or extends into or pulls itself out of the plunger (or valve core), a certain friction force is generated, which can drive the valve core of the control valve to move within a certain range, so as to make a connection relationship between the passages of the valve core and the tubes of the valve body change; due to movement of the plunger therein, the sliding component (rod-like object) drives the valve core of the control valve to move within a certain range, so as to make a connection relationship between the passages of the valve core and the tubes of the valve body change. As the valve core of the control valve is connected to the plunger via the sliding component, the passages of the valve core moves more quickly to the position where the passages communicate with the tubes of the valve body with the pressure change of the pressure changing part, and respond more sensitively under a negative pressure and pressurization, to prevent accidents that content in the pressure transferring channel and the control valve flows into the container under the pressurization and content in the outflow channel enters into the pressure transferring channel and the control valve under the negative pressure.

Compared with the foregoing manners of removing by pressure, such as the pressing pump, by means of a control valve, the container has the following advantages: 1. the structure is simpler, reducing the manufacturing cost; 2. it is more durable, and a fault does not easily occurs after repeated use; 3. the channel diameter of the control valve is larger, reducing the pressure drop in the whole removal process, and making the removal easier, which also makes it possible to remove viscous liquids such as pastes; 4. the control valve has better sealing performance, can make the removal easier and quantitative determination more accurate; and 5. the amount of single removal is great, the content in the whole pressure transferring channel can be removed, and stepless continuous removal can be achieved basically.

Compared with methods of removing by means of a combination of multiple check valves, the removal system of the container has advantages of a simpler structure, a lower manufacturing cost, being durable, a larger channel communication diameter and good sealing performance on the whole.

The control valve is in communication with the bottom of the container body, the pressure transferring channel and the outflow channel, and controls connection or disconnection of two channels between the pressure transferring channel and the outflow channel and between the bottom of the container body and the pressure transferring channel, and the control valve has a simple structure and convenient operation and is very suitable for containers for removal under variable pressure.

For the container, the pressure transferring channel is connected to the pressure changing part and the control valve, and its internal pressure periodically varies with the removal process of the content. When the content is removed through pressurization, the pressure in the pressure transferring channel becomes larger, and the content in the channel flows outwards via the control valve and the outflow channel under the pressure; after the removal, due to the action of the pressure changing part, a negative pressure occurs in the pressure channel, the content in the container body enters the pressure transferring channel via the control valve, the pressure is balanced, and the container is ready for next removal.

For the container, the valve core of the control valve has at least two positions in the valve body, where the position on one end enables connection between the bottom of the container body and the pressure transferring channel and disconnection between the pressure transferring channel and the outflow channel; and the position on the other end enables connection between the pressure transferring channel and the outflow channel and disconnection between the bottom of the container body and the pressure transferring channel. It is common that the valve core is in the middle position of the valve body, and at this point, the bottom of the container body and the pressure transferring channel as well as the pressure transferring channel and the outflow channel are disconnected from each other. Such a control valve is different from the structure or use of other conventional control valves, the structure of the control valve is simpler and more durable, has a larger channel communication diameter and better sealing performance on the whole, and can be used conveniently and determine quantity accurately.

For the container, the sliding component is a telescopic rod, a straight rod or a tubular object. The sliding component makes a passage communicate with a required tube so as to achieve that the valve core can be driven to move in the valve body, and discharges content from the pressure transferring channel (sucking the content from the container body into the pressure transferring channel) so as to achieve continuous pressurization (decompression) and shorten (extend) the distance between the plunger and the valve core.

For the container, the sliding component is provided in specific positions with bands having different friction forces. This enables a user to feel that the plunger has moved to the position during removal, so that the user can feel the volume of the content removed without visual observation. This is suitable for places with greater smoke and water vapor, for example, a kitchen.

For the container, it is feasible to dispose a spring at the bottom of the vale core of the control valve. The spring disposed at the bottom of the vale core of the control valve can make the valve core leave the tube communicating with the outflow channel after the content is removed through pressurization, and can prevent the content in the pressure transferring channel and the control valve from accidentally flowing out or being polluted due to communication with the outflow channel during non-removal time.

For the container, it is feasible to make the tube communicating with the outflow channel located on an upper portion of the valve body. When the tube communicating with the outflow channel is located on an upper portion of the valve body, under pressurization, it is conductive to discharging gas sneaking into the pressure transferring channel and the control valve out from the outflow channel.

For the container, the container body may have multiple spaces to respectively contain different content, and when the external pressure changing part generates the negative pressure, the spaces respectively connects the pressure transferring channel at the same time. The container with such a structure enables simultaneous removal of a mixture of multiple content in the pressure transferring channel before use, and prevents undesired changes of the content caused by too early mixing.

For the container having a pressure changing part, the pressure changing part may be a cylindrical object internally provided with a plunger that can be pushed or pulled. The plunger that can be pushed or pulled may be a plunger connected with the sliding component, to decrease the number of parts and reduce the pressure drop of the channel. At this point, the push-pull rod may have scales thereon, used for indicating a distance of movement of the plunger or the volume of the removed content.

For the container having a pressure changing part, the opening on the valve body may lead to the outflow channel. If the opening can communicate with the outflow channel, under pressurization, all the content discharged via the valve body flows out via the outflow channel, which can precisely determine the volume of the content flowing out via the outflow channel by measuring the volume of the content discharged via the pressure transferring channel. On the other hand, under decompression, the valve core moves towards one side of the pressure transferring channel, which will drive a small amount of the content in the outflow channel to flow back into the valve body via the opening, and prevent the content from dripping from the outlet of the outflow channel when not pressurized to cause pollution and waste.

For the container having a pressure changing part, a connecting part internally provided with a plunger that can be pushed or pulled which connects the pressure changing part is provided with a circular ring available for a finger to extend into. This enables the user to achieve single-handed operation (which can increase pressure and can also reduce the pressure), and has good user experience.

The container also overcomes various problems existing in the container of the prior art and have the following advantages such as the container saves materials, prevent leakage, is easy to use, can be reused, is portable to take, is not easy to damage, has good reproducibility, prevents product pollution, saves the content, enables precise removal, enables removal of content with great viscosity and consistency, has a simple structure, is practicable, not prone to damage and widely used. Moreover, the container has greater capacity, can be recycled, can reduce applications of various packaging such as plastics, and is helpful to reduce the pressure of environmental pollution.

In another aspect, the present invention further provides a method for removing content in a container, including the following two steps from A to B or B to A:

A. generating a negative pressure by using a pressure changing part, and via transfer by a pressure transferring channel and a sliding component, pushing a valve core in a control valve to move, so that the pressure transferring channel communicates with a channel leading to the bottom of a container body through a passage and a tube, to urge the content in the container body to flow out into the pressure transferring channel; after the negative pressure disappears, the content in the container body stopping flowing out into the pressure transferring channel; and

B. pressurizing the pressure transferring channel by using the pressure changing part, and via transfer by the pressure transferring channel and the sliding component, pushing the valve core in the control valve to move, so that the pressure transferring channel communicates with an outflow channel through a passage and a tube, to urge the content to flow outwards; and stopping pressurizing after a required amount of the content is removed, and the content stopping flowing out;

wherein the pressure changing part is a part that can generate a positive and negative pressure change in the pressure transferring channel;

the pressure transferring channel is internally provided with a plunger that reciprocates with the pressure change generated by the pressure changing part;

the outflow channel is a channel that allows the content to flow out of the container;

the control valve includes a valve body and a valve core, the valve core being located in a valve body cavity;

the valve body is provided with an opening on one side opposite the pressure transferring channel;

the valve body is provided with at least two tubes, respectively in communication with a channel leading to the bottom of the container body and the outflow channel;

the valve core of the control valve is provided with an inner channel and at least one passage, the inner channel communicating with the pressure transferring channel and the passage; and

the valve core of the control valve is connected with the plunger via the sliding component, thus allowing the plunger to drive the valve core to move in the valve body when the pressure generated by the pressure changing part changes.

Such a removal method is easy to operate and easy to use, enables accurate quantitative determination, basically realizes stepless continuous removal, can be applied to liquids or pastes with greater viscosity and consistency, and can also be applied to liquids to be removed in a spray shape or a foam shape.

### BRIEF DESCRIPTION OF THE DRAWINGS

FIG. 1 is a schematic structural view of the container in Embodiment 1;

FIG. 2 is a partially enlarged view of A in FIG. 1;

FIG. 3 is a schematic structural view of the container in Embodiment 2;

FIG. 4 is a partially enlarged view of A in FIG. 3;

FIG. 5 is a schematic structural view of the container in Embodiment 3;

FIG. 6 is a partially enlarged view of A in FIG. 5;

FIG. 7 is a schematic structural view of the container in Embodiment 4; and

FIG. 8 is a partially enlarged view of A in FIG. 7.

### DETAILED DESCRIPTION

### Embodiment 1

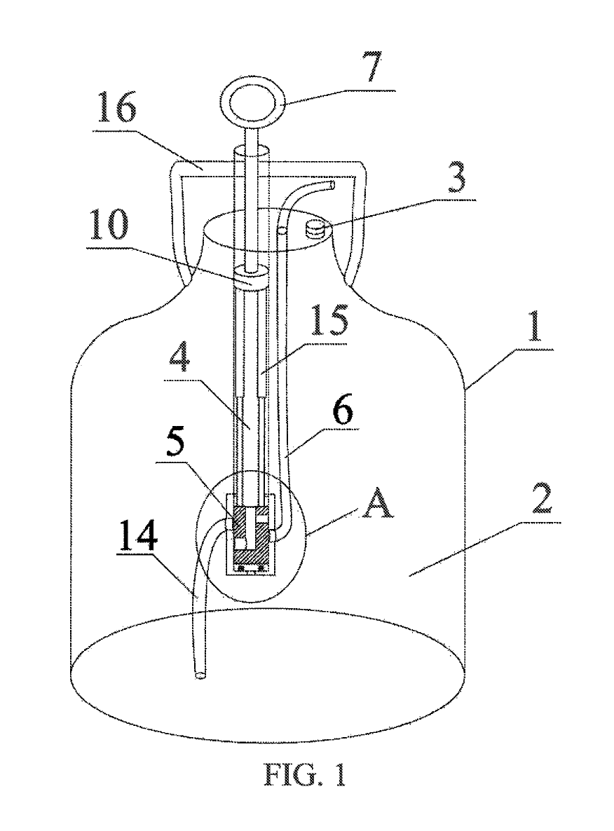

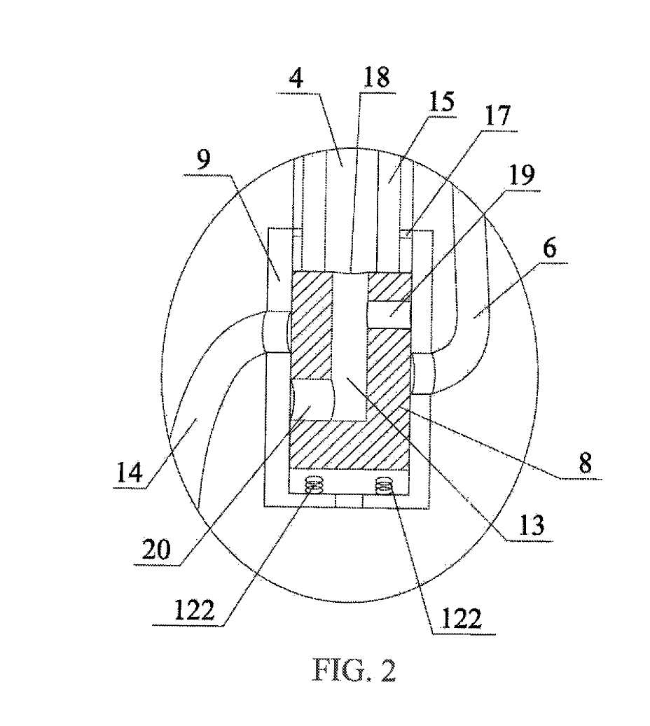

As shown in FIG. 1, FIG. 1 illustrates a container according to Embodiment 1, and FIG. 2 is an enlarged view of the part A in FIG. 1. The container includes a container body 1, an upper portion of the container body 1 has a filling port, and after the content 2 is filled, the filling port is sealed with the check valve 3. The check valve 3 only allows gas to enter into the container body 1. A handle 16 is connected outside the container body 1.

The middle position of the container body 1 is installed with a pressure transferring channel 4 extending into its interior. The container body 1 and the pressure transferring channel 4 are airtight. A lower end of a channel wall of the pressure transferring channel 4 is connected to a valve body 9 of a control valve 5. The pressure transferring channel 4 is internally provided with a plunger 10, and an upper portion of the plunger 10 is provided with a pull rod having a ring 7 on the top. The pull rod is marked with scales thereon, used for indicating the volume of content flowing out. Two telescopic rods 15 are connected to a lower portion of the plunger 10, and lower portions of the telescopic rods 15 are connected to a valve core 8 of the control valve 5. An average person extends his/her thumb into the ring 7, grips the handle 16 with four fingers, and moves the thumb up and down to drive the plunger 10 to move up and down, which can drive the valve core 8 of the control valve 5 to move up and down within a certain distance range (in the valve body 9).

The control valve 5 includes the valve core 8 and the valve body 9. The valve body 9 can communicate with a channel 14 and an outflow channel 6 via a tube thereon; and communicates with the pressure transferring channel 4 via an opening 18 thereon. The channel 14 leads to the bottom of the container body 1. The valve core 8 of the control valve 5 is located in an inner cavity of the valve body 9, and can reciprocate in the cavity, but peripheral sides of the valve core 8, except the part of the passage, are liquid-sealed with the valve body 9. The valve core 8 has an inner channel 13, and the inner channel 13 has an opening 18, a passage 19 and a passage 20. The inner channel 13 communicates with the pressure transferring channel 4 via the opening 18 on the valve body 9. According to different positions where the valve core 8 reciprocates in the valve body 9, three different connection relationships exist between the passage 19, the passage 20 and the channel 14, the outflow channel 6: when the valve core is in the middle position of the valve body, the passage 20 and the channel 14 as well as the passage 19 and the outflow channel 6 are not connected; when the valve core is located on one side in the valve body which is near the pressure transferring channel, only the passage 20 and the channel 14 are connected, while the passage 19 and the outflow channel 6 are not connected; when the valve core is located on one side in the valve body which is away from the pressure transferring channel, only the passage 19 and the outflow channel 6 are connected. The bottom of the cavity is installed with a spring 122, and the spring 122 can cause the valve core 8 to be in a position where the passage 19 and the outflow channel 6 are not connected when there is no external pressure. The spring 122 can prevent that continuous downward movement of the plunger drives the valve core to continuously move downwards after the passage 19 and the outflow channel 6 are connected; a baffle 17 can prevent that continuous upward movement of the plunger drives the valve core to continuously move upwards after the passage 20 and the channel 14 are connected. The valve body 9 opposite the opening 18 is provided with an opening, to enable the valve core 8 to reciprocate in the valve body 9 smoothly.

An outflow end of the outflow channel 6 extends out of the container body.

In this embodiment, an airbag having an elastic recovery function may also be used as the pressure changing part, which is installed to an outer end of the pressure transferring channel.

For the container, steps of removing content in the container are as follows:

A thumb is extended into the ring 7, the handle 16 is gripped with four fingers, the thumb is moved downwards to drive the plunger 10 to move downwards, so as to drive the valve core 8 of the control valve 5 to move downwards within a certain distance range, to make the passage 19 and the outflow channel 6 connected, and the thumb is continuously moved, to make the content in the pressure transferring channel 4 flow outwards along the outflow channel 6.

Pressurization stops after a required amount of the content is removed, the content stops flowing out, the valve core 8 of the control valve 5 moves towards the pressure transferring channel 4 under the action of the spring 122, and the passage 19 and the outflow channel 6 are disconnected from each other.

The thumb is moved upwards, the ring 7 drives the plunger 10 to move upwards, so as to drive the valve core 8 of the control valve 5 to move upwards within a certain distance range, that is, the valve core 8 of the control valve 5 moves towards the pressure transferring channel 4, and the passage 20 and the channel 14 are connected. The thumb is continuously moved upwards, and under a negative pressure, the content 2 enters the pressure transferring channel 4 along the channel 14 and the inner channel 13.

After movement of the thumb stops, the content entering fills the pressure transferring channel 4 to make the negative pressure disappear, and the valve core 8 of the control valve 5 stops moving. The spring 122 can prevent unexpected connection between the passage 19 and the outflow channel 6.

At this time, the container is ready for next removal. The content can be removed once again if the thumb is moved downwards.

The check valve 3, under external atmosphere, makes gas outside the container body enter into the container, until internal and external pressures of the container body 1 are equal. Due to existence of the check valve 3, only a limited amount of outside gas can contact the content in the container body 1, which may reduce pollution or oxidation of the content.

A combination of the ring 7 and the handle 16 can achieve single-handed operation and makes removal operation more convenient. At the same time, scales can be marked on a connecting rod between the ring 7 and the plunger 10, used for indicating the position of the plunger (representing the volume of the removed content).

### Embodiment 2

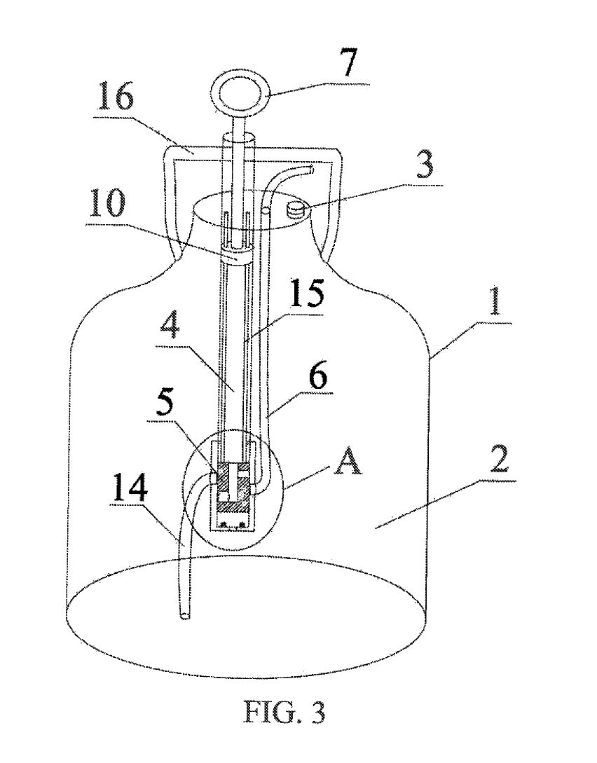

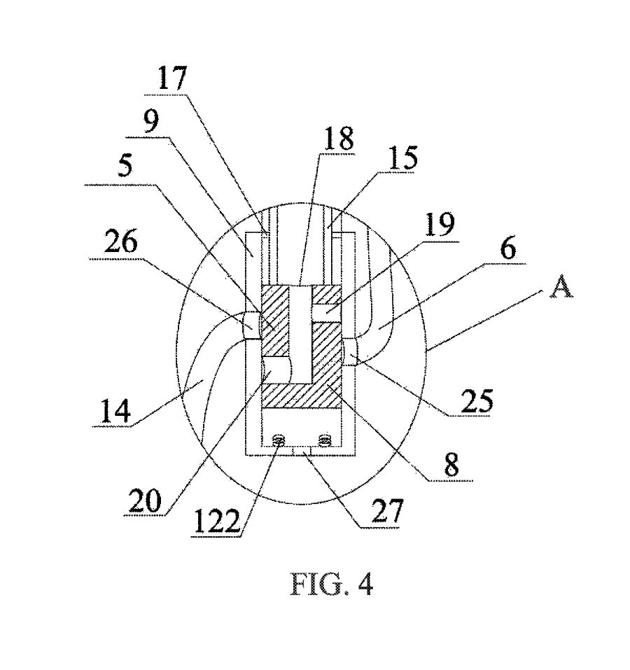

As shown in FIG. 3, FIG. 3 illustrates a container according to Embodiment 2, and FIG. 4 is an enlarged view of the part A of FIG. 3. The container includes a container body 1, an upper portion of the container body 1 has a filling port, and after the content 2 is filled, the filling port is sealed with the check valve 3. The check valve 3 only allows gas to enter into the container body 1. A handle 16 is connected outside the container body 1.

The middle position of the container body 1 is installed with a pressure transferring channel 4 extending into its interior. The container body 1 and the pressure transferring channel 4 are airtight. A lower end of a channel wall of the pressure transferring channel 4 is connected to a valve body 9 of a control valve 5. The pressure transferring channel 4 is internally provided with a plunger 10, and an upper portion of the plunger 10 is provided with a pull rod having a ring 7 on the top. Two straight rods 15 are penetrated through the plunger 10, and the straight rods 15 can reciprocate on the plunger 10. Lower portions of the straight rods 15 are connected to a valve core 8 of the control valve 5. An average person extends his/her thumb into the ring 7, grips the handle 16 with four fingers, and moves the thumb up and down to drive the plunger 10 to move up and down, which can drive the valve core 8 of the control valve 5 to move up and down within a certain distance range (in the valve body 9).

The control valve 5 includes the valve core 8 and the valve body 9. The valve body 9 can communicate with an outflow channel 6 and a channel 14 via a tube 25 and a tube 26 thereon; and the valve core 8 and an opening 18 on the valve body 9 communicate with the pressure transferring channel 4. The channel 14 leads to the bottom of the container body 1. The valve core 8 of the control valve 5 is located in an inner cavity of the valve body 9, and can reciprocate in the cavity, but peripheral sides of the valve core 8, except the part of the passage, are liquid-sealed with the valve body 9. The valve core 8 has an inner channel 13, and the inner channel 13 has an opening 18, a passage 19 and a passage 20. The opening 18 communicates with the pressure transferring channel 4. According to different positions where the valve core 8 reciprocates in the valve body 9, three different connection relationships exist between the passage 19, the passage 20 and the channel 14, the outflow channel 6: when the valve core is located on one side in the valve body which is near the pressure transferring channel, only the passage 20 and the channel 14 are connected; when the valve core is in the middle position of the valve body, the passage 20 and the channel 14 as well as the passage 19 and the outflow channel 6 are not connected (the state as shown in FIG. 1 and FIG. 2); when the valve core is located on one side in the valve body which is away from the pressure transferring channel, only the passage 19 and the outflow channel 6 are connected. The bottom of the cavity is installed with a spring 122, and the spring 122 can cause the valve core 8 to be in a position where the passage 19 and the outflow channel 6 are not connected when there is no external pressure. The spring 122 can prevent that continuous downward movement of the plunger drives the valve core to continuously move downwards after the passage 19 and the outflow channel 6 are connected; a baffle 17 can prevent that continuous upward movement of the plunger drives the valve core to continuously move upwards after the passage 20 and the channel 14 are connected. The valve body 9 opposite the opening 18 is provided with an opening 27, to enable the valve core 8 to reciprocate in the valve body 9 smoothly. An outflow end of the outflow channel 6 extends out of the container body.

In this embodiment, by setting bands with different friction forces (for example, greater friction forces) in specific positions of the straight rods, the user can feel that the plunger has moved to the position during removal. The specific positions can represent the integral volume of the removed content, for example, 10 ml, 20 ml, 30 ml and so on.

The method of removing the content is similar to that in Embodiment 1.

### Embodiment 3

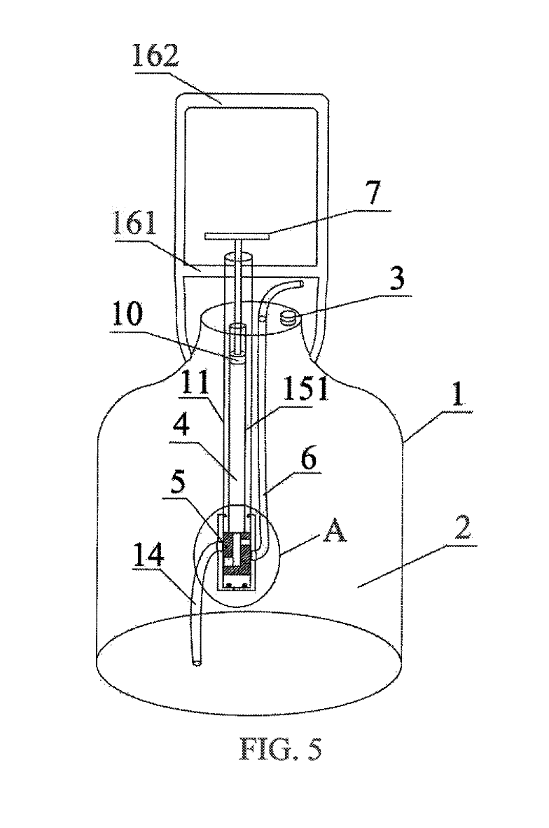

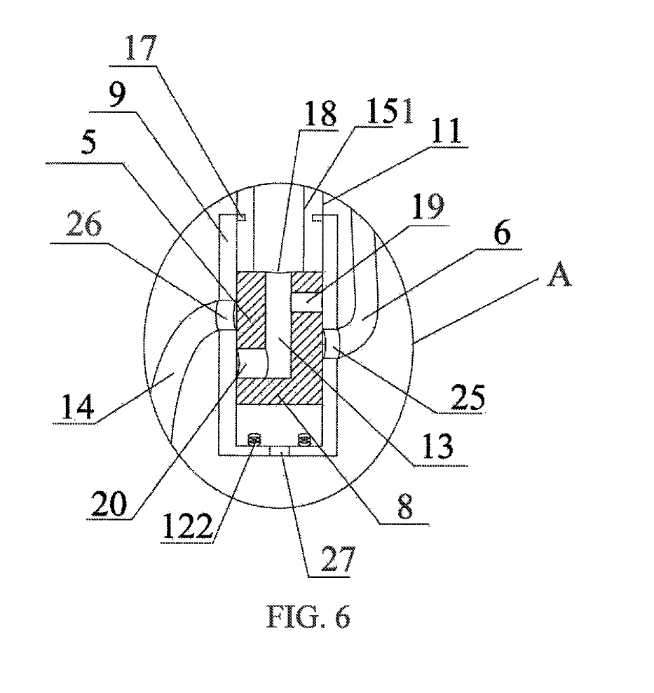

As shown in FIG. 5, FIG. 5 illustrates a container according to Embodiment 3, and FIG. 6 is an enlarged view of the part A of FIG. 5. The container includes a container body 1, an upper portion of the container body 1 has a filling port, and after the content 2 is filled, the filling port is sealed with the check valve 3. The check valve 3 only allows gas to enter into the container body 1. A handle 161 and a handle 162 are connected outside the container body 1.

The middle position of the container body 1 is installed with a tubular object 11 extending into its interior. The tubular object 11 and an opening of the container body 1 are airtight. A lower portion of the tubular object 11 is connected to a valve body 9 of a control valve 5, used for fixing the control valve 5. A straight pipe 151 is disposed in the tubular object 11, and a lower end of the straight pipe 151 is connected to a valve core 8 of the control valve 5. The straight pipe 151 is internally provided with a plunger 10, and an upper portion of the plunger 10 is provided with a pull rod having a ring 7 on the top. Inside the straight pipe 151 in a lower portion of the plunger 10 is a pressure transferring channel 4. Up and down movement of the plunger 10 can drive positions of the valve core 8 in the valve body 9 to change via the straight pipe 151.

The control valve 5 includes the valve core 8 and the valve body 9. The valve body 9 can communicate with an outflow channel 6 and <channel 14 via a tube 25 and a tube 26 thereon; and the valve core 8 and an opening 18 on the valve body 9 communicate with the pressure transferring channel 4. The channel 14 leads to the bottom of the container body 1, and an outflow end of the outflow channel 6 extends out of the container body. The valve core 8 of the control valve 5 is located in an inner cavity of the valve body 9, and can reciprocate in the cavity, but peripheral sides of the valve core 8, except the part of the passage, are liquid-sealed with the valve body 9. The valve core 8 has an inner channel 13, and the inner channel 13 has an opening 18, a passage 19 and a passage 20. The opening 18 communicates with the pressure transferring channel 4. According to different positions where the valve core 8 reciprocates in the valve body 9, three different connection relationships exist between the passage 19, the passage 20 and the channel 14, the outflow channel 6: when the valve core is located on one side in the valve body which is near the pressure transferring channel, only the passage 20 is connected with the channel 14 via the tube 26; when the valve core is in the middle position of the valve body, the passage 20 and the channel 14 as well as the passage 19 and the outflow channel 6 are not connected (the state as shown in FIG. 1 and FIG. 2); when the valve core is located on one side in the valve body which is away from the pressure transferring channel, only the passage 19 is connected with the outflow channel 6 via the tube 25. The bottom of the cavity is installed with a spring 122, and the spring 122 can cause the valve core 8 to be in a position where the passage 19 and the outflow channel 6 are not connected when there is no external pressure. The spring 122 can prevent that continuous downward movement of the plunger drives the valve core to continuously move downwards after the passage 19 and the outflow channel 6 are connected; a baffle 17 can prevent that continuous upward movement of the plunger drives the valve core to continuously move upwards after the passage 20 and the channel 14 are connected. The valve body 9 opposite the opening 18 is provided with an opening 27, to enable the valve core 8 to reciprocate in the valve body 9 smoothly. The opening 7 can communicate with the outflow channel via one tube.

In this embodiment, it is also feasible to set bands with different friction forces (for example, greater friction forces) in specific positions on inner walls of the tubular object, to make the user feel that the plunger has moved to the position during removal. Meanwhile, if a band with a greater friction force is disposed at the highest level on the inner walls of the tubular object, the plunger 10 can smoothly drive the valve core 8 to move downwards, so that the passage 19 and the outflow channel 6 can communicate with each other smoothly.

When the content is moved, the straight rod 7 and the handle 161 are gripped with a single hand, a distance between them is shortened through extrusion, the plunger 10 is pressed downwards, to drive the valve core 8 to move downwards via the straight pipe 151, and the passage 19 can communicate with the outflow channel 6 smoothly via the tube 25. The plunger 10 is continuously pressed downwards, the spring 122 blocks continuous downward movement of the valve core 8, and the content in the pressure transferring channel 4 flows out of the outflow channel 6. After removal, the straight rod 7 and the handle 162 are gripped with a single hand, a distance between them is shortened through extrusion, the plunger 10 is pulled up, to drive the valve core 8 to move upwards via the straight pipe 151, and the passage 20 can communicate with the channel 14 smoothly via the tube 26. The plunger 10 is continuously pulled up, the baffle 17 blocks continuous upward movement of the valve core 8, and the content in the container body 1 flows out into the pressure transferring channel 4 under a negative pressure.

### Embodiment 4

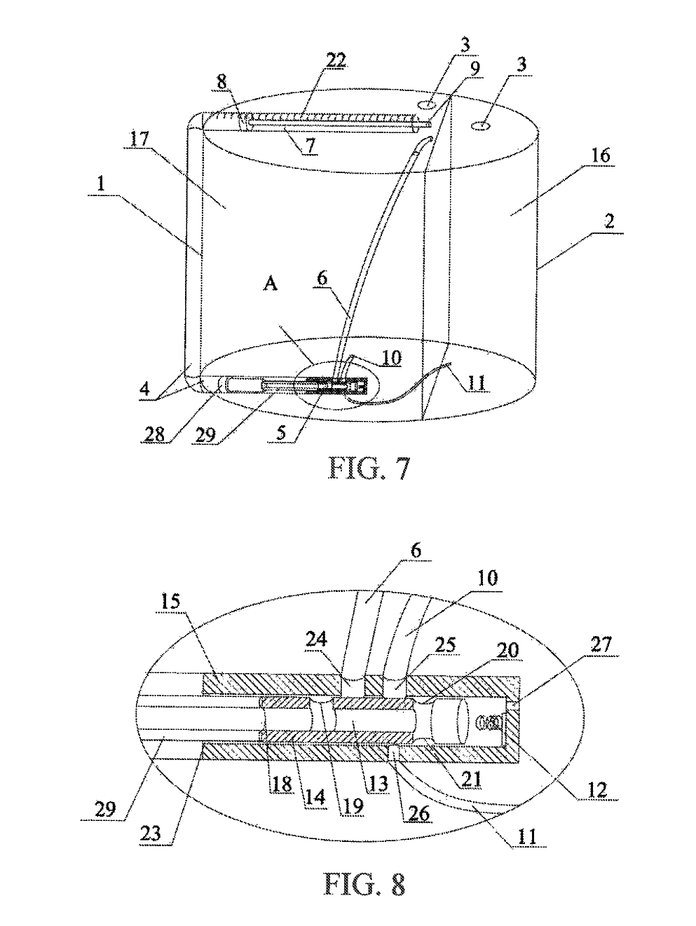

As shown in FIG. 7 and FIG. 8, FIG. 7 illustrates a container according to Embodiment 4, and FIG. 8 is an enlarged view of the part A of FIG. 7. The container body includes two parts: a space 1 and a space 2, which are respectively filled with content 17 and content 16. After being filled with the content, filling ports of the space 1 and the space 2 are respectively blocked with check valves 3, and the check valves 3 only allow gas to enter into the container body 1, to prevent the content 16 and the content 17 from volatilizing outwards.

A pressure changing part 7 is located at the top of the container, including a plunger 8, a pressurized bar 9 and a cylindrical object 22 with scales. The pressure changing part 7 is in communication with a pressure transferring channel 4, the pressure transferring channel 4 is internally provided with a plunger 28, the plunger 28 is connected to a telescopic rod 29, and the telescopic rod 29 is connected to a valve core 14 of a control valve 5. Good airtightness exists between the pressure changing part 7, the pressure transferring channel 4 as well as a valve body 15 of the control valve 5 and the outside.

The control valve 5 includes the valve body 15 and a valve core 14. The valve core 14 can slide left and right in the valve body 15, and a spring 12 installed on the valve body 15 enables the valve core 14 to leave the right end of the valve body after the content is removed. The valve core 14 has an inner channel 13 therein, and the inner channel 13 has an opening 18, a passage 19, a passage 20 and a passage 21. The opening 18 is in communication with the right side of the plunger 28 of the pressure transferring channel 4 through an opening of the valve body 15. During pressurization of the pressure changing part 7, the opening 19 moves to a position where it communicates with a channel 24 on the valve body, and the channel 24 communicates with an outflow channel 6. During decompression of the pressure changing part 7, the passage 20 and the passage 21 move to positions where they respectively communicate with a tube 25 and a tube 26 on the valve body. The tube 25 and the tube 26 respectively communicate with a channel 10 and a channel 11. The channel 10 and the channel 11 respectively communicate with the bottom of the space 1 and the bottom of the space 2. In the absence of pressurization of the pressure changing part, under the action of the spring 12, the passage 19 does not communicate with the outflow channel 6 outside the valve body. A cross-sectional-area ratio of the tube 25 to the tube 26 is correlated with a volume ratio of the space 1 to the space 2, and their opening positions are located on the same cross section of the control valve 5. An opening 27 aims at enabling the valve core 14 to move left and right smoothly. The spring 12 can also prevent that continuous right movement of the plunger drives the valve core 14 to continuously move to the right after the passage 19 moves to the position where it communicates with the tube 24 on the valve body under pressurization; the baffle 23 can prevent that continuous left movement of the plunger drives the valve core 14 to continuously move to the left after the passage 20 and the passage 21 respectively communicate with the tube 25 and the tube 26 under the negative pressure.

For the container, steps of removing the content therein are as follows:

An operating lever 9 is pressed to the right, to make the pressure changing part 7 pressurize the pressure transferring channel 4.

The plunger 28 moves to the right, to drive the valve core 14 of the control valve 5 to move towards the right side via the telescopic rod 29, so that the opening 19 communicates with the outflow channel 6 through the tube 24 and the content in the whole channel flows outwards along the outflow channel 6.

Variation of the location of the plunger 8 is observed, pressurization stops after a required amount of the content is removed, and the content stops flowing out. The valve core 14 moves towards the left side under the action of the spring 12, and the passage 19 and the tube 24 are disconnected (as shown in FIG. 7 and FIG. 8, the passage 20 and the tube 25 as well as the passage 21 and the tube 26 are also disconnected).

The operating lever 9 is pulled to the left, so that the pressure changing part 7 decompresses the pressure transferring channel 4, that is, a negative pressure is generated, the valve core 14 moves to the left side, and the passage 20 and the tube 25 as well as the passage 21 and the tube 26 are connected; under the negative pressure, the content 17 and the content 16 enter the control valve 5 respectively through the tube 10 and the tube 11, and then enter the pressure transferring channel 4; and the volume ratio of the content entering is positively correlated with the cross-sectional-area ratio of the tube 25 to the tube 26.

As the content enters into the control valve 5 and the pressure transferring channel 4, the check valves 3 make gas with a volume the same as that of the outflow liquid enter the space 1 and the space 2 respectively, until internal and external pressures of the container body 1 are equal. Accordingly, only a limited amount of outside gas can contact the content in the space 1 and the space 2, which will not cause pollution or oxidization to the content.

At this time, the container is ready for next taking-out.

Although the embodiments of the present invention have been illustrated and described above, it would be understood by persons of ordinary skill in the art that various variations, modifications, replacements, transformations and combinations can be made to the embodiments without departing from the principle and spirit of the present invention. The scope of the present invention is defined by the appended claims and equivalents thereof.

What is claimed is:

1. A self-measuring container, comprising a container body, characterized by further comprising a pressure changing part, a pressure transferring channel, a control valve and an outflow channel;
the pressure changing part being a part that can generate a positive and negative pressure change in the pressure transferring channel;
the pressure transferring channel being internally provided with a plunger that reciprocates with the pressure change generated by the pressure changing part, the plunger being capable of transferring to the control valve a pressure applied to the pressure transferring channel by the pressure changing part;
the outflow channel being a channel that allows content to flow out of the container;
the control valve comprising a valve body and a valve core, the valve core being located in a valve body cavity;
the valve body being provided with an opening on one side opposite the pressure transferring channel;
the valve body being provided with at least two tubes, respectively in communication with a channel leading to the bottom of the container body and the outflow channel;
the valve core of the control valve being provided with an inner channel and at least one passage, the inner channel communicating with the pressure transferring channel and the passage;
the valve core of the control valve being connected to the plunger via a sliding component, thus allowing the plunger to drive the valve core to move in the valve body when the pressure generated by the pressure changing part changes; and
when the pressure changing part generates a positive pressure, the valve core being located on one side in the valve body which is away from the pressure transferring channel, and the passage communicating with the tube on the valve body which leads to the outflow channel and being disconnected from the tube on the valve body which leads to the bottom of the container body; when the pressure changing part generates a negative pressure, the valve core being located on one side in the valve body which is near the pressure transferring channel, and the passage communicating with the tube on the valve body which leads to the bottom of the container body and being disconnected from the tube on the valve body which leads to the outflow channel.

2. The container according to claim 1, characterized in that: the plunger is a component of the pressure changing part.

3. The container according to claim 1, characterized in that: the sliding component is provided in specific positions with bands having different friction forces.

4. The container according to claim 1, characterized in that: the valve body cavity on one side opposite the pressure transferring channel is provided with a spring.

5. The container according to claim 1, characterized in that: the container body has multiple spaces to respectively contain different contents, and when the external pressure changing part generates the negative pressure, the spaces respectively connects the pressure transferring channel through the tubes and the passage at the same time.

6. The container according to claim 1, characterized in that: the sliding component is a telescopic rod, a straight rod or a tubular object.

7. The container according to claim 1, characterized in that: the tube in communication with the outflow channel is located on an upper portion of the valve body.

8. The container according to claim 1, characterized in that: the opening on the valve body leads to the outflow channel.

9. The container according to claim 1, characterized in that: the pressure changing part is a cylindrical object internally provided with a plunger that can be pushed or pulled.

10. The container according to claim 9, characterized in that: a connecting part internally provided with a plunger that can be pushed or pulled which connects the pressure changing part is provided with a circular ring available for a finger to extend into.

11. The container according to claim 9, characterized in that: the connecting part internally provided with a plunger that can be pushed or pulled is marked thereon with scales, used for indicating the volume of content removed.

12. A method for removing content in a container, comprising the following two steps from A to B or B to A:
A. generating a negative pressure by using a pressure changing part, and via transfer by a pressure transferring channel and a sliding component, pushing a valve core in a control valve to move, so that the pressure transferring channel communicates with a channel leading to the bottom of a container body through a passage and a tube, to urge the content in the container body to flow out into the pressure transferring channel; after the negative pressure disappears, the content in the container body stopping flowing out into the pressure transferring channel; and
B. pressurizing the pressure transferring channel by using the pressure changing part, and via transfer by the pressure transferring channel and the sliding component, pushing the valve core in the control valve to move, so that the pressure transferring channel communicates with an outflow channel through a passage and a tube, to urge the content to flow outwards; and stopping pressurizing after a required amount of the content is removed, and the content stopping flowing out;
wherein the pressure changing part is a part that can generate a positive and negative pressure change in the pressure transferring channel;
the pressure transferring channel is internally provided with a plunger that reciprocates with the pressure change generated by the pressure changing part;
the outflow channel is a channel that allows the content to flow out of the container;
the control valve comprises a valve body and a valve core, the valve core being located in a valve body cavity;
the valve body is provided with an opening on one side opposite the pressure transferring channel;
the valve body is provided with at least two tubes, respectively in communication with a channel leading to the bottom of the container body and the outflow channel;
the valve core of the control valve is provided with an inner channel and at least one passage, the inner channel communicating with the pressure transferring channel and the passage; and
the valve core of the control valve is connected with the plunger via the sliding component, thus allowing the plunger to drive the valve core to move in the valve body when the pressure generated by the pressure changing part changes.
